(19) United States
(12) Patent Application Publication
(10) Pub. No.: US 2025/0382692 A1
(43) Pub. Date: Dec. 18, 2025

(54) ULTRA-THIN LITHIUM FOIL MANUFACTURING APPARATUS USING MOLTEN METAL DROPLET SPRAYING

(71) Applicant: SEOUL NATIONAL UNIVERSITY R&DB FOUNDATION, Seoul (KR)

(72) Inventors: Yun Seog LEE, Seoul (KR); Ho Young KIM, Seoul (KR); Jung Taek KIM, Seoul (KR); Seungeun PAIK, Seoul (KR)

(73) Assignee: SEOUL NATIONAL UNIVERSITY R&DB FOUNDATION, Seoul (KR)

(21) Appl. No.: 18/890,305

(22) Filed: Sep. 19, 2024

Related U.S. Application Data
(63) Continuation of application No. PCT/KR2024/008219, filed on Jun. 14, 2024.

(51) Int. Cl. C23C 4/123; H01M 4/04

(52) U.S. Cl. CPC C23C 4/123; H01M 4/0419

(57) ABSTRACT

An ultra-thin lithium foil manufacturing apparatus includes: a crucible configured to apply heat to molten metal supplied from an external source to maintain a molten state of metal; a nozzle portion installed at one end of the crucible to eject the molten metal; a piezoelectric transducer installed at the other end of the crucible to transmit an excitation force to the molten metal in the crucible at a frequency set by a function generator; and a pressurizing pipe coupled to the crucible to transmit a pressurizing force to the molten metal. The crucible and the nozzle portion move within a set range while the molten metal is ejected through the nozzle portion. The present invention provides an ultra-thin lithium foil manufacturing apparatus using molten metal droplet spraying capable of manufacturing thinner lithium films beyond the thickness limitations of existing manufacturing techniques.

### CROSS-REFERENCE TO RELATED APPLICATIONS

This application is a continuation of PCT/KR2024/008219 filed on Jun. 14, 2024, the entire contents of which are herein incorporated by reference.

### TECHNICAL FIELD

The present invention relates to the manufacture of various energy storage devices, such as fuel cells, and more particularly to an apparatus for applying lithium droplets to form electrodes suitable for use in various energy storage devices, including batteries and capacitors.

### BACKGROUND

Lithium and lithium-ion secondary or rechargeable batteries have found use in certain applications such as in cellular phones, camcorders, and laptop computers, and even more recently, in larger power applications such as in electric vehicles and hybrid electric vehicles. It is preferred in these applications that the secondary batteries have the highest specific capacity possible but still provide safe operating conditions and good cycleability so that the high specific capacity is maintained in subsequent recharging and discharging cycles.

There are various constructions for secondary batteries, but each construction includes a positive electrode (or cathode), a negative electrode (or anode), a separator separating the cathode and the anode, and an electrolyte electrochemically connecting the cathode and the anode. For a secondary lithium battery, lithium ions are transported from the anode to the cathode through the electrolyte when the secondary battery is discharged, ie when used for its specific application. During the discharge process, electrons are collected from the anode and passed through an external circuit to the cathode. When the secondary battery is charged or recharged, lithium ions are transported from the cathode to the anode through the electrolyte.

Historically, secondary lithium batteries were produced using non-lithiated compounds having high specific capacities such as TiS₂, MoS₂, MnO₂ and V₂O₅, as the cathode active materials. These cathode active materials were connected with a lithium metal anode. When the secondary battery was discharged, lithium ions diffused and migrated from the lithium metal anode to the cathode through the electrolyte. Unfortunately, when cycling, the lithium metal generated dendrite, which ultimately caused unsafe conditions in the battery. As a result, the manufacture of these types of secondary batteries ceased in the early 1990s, favoring lithium-ion batteries.

Lithium-ion batteries typically use lithium metal oxides such as LiCoO₂ and LiNiO₂ as cathode active materials (which are linked with active anode materials such as carbon-based materials). It is recognized that there are other anode types based on silicon oxide, silicon particles, and the like. In batteries using carbon-based anode systems, the formation of lithium dendrites on the anode is substantially prevented, thereby making the battery safer. However, lithium (the amount of which determines the battery capacity) is supplied entirely from the cathode. This limits the selection of the cathode active material, as the active material must contain extractable lithium. Also, delithiated products corresponding to LiₓCoO₂ and LiₓNiO₂ formed during charging and overcharging are not stable. In particular, these delithiated products tend to react with the electrolyte and generate heat, which raises safety concerns.

In addition, in order for lithium to be used as a high-performance battery material, a thin thickness must be secured, but there is a problem in that it is difficult to manufacture it below 20 μm due to the mechanical properties of lithium using the existing cold rolling method.

Therefore, a method of spontaneously infiltrating molten lithium into a current collector with three-dimensional structure is also being studied, but this method has a problem that it is difficult to control the thickness and is not suitable for large-area continuous processes.

In order to improve the performance of energy storage devices such as fuel cells, a manufacturing platform that overcomes the thickness limitations of lithium cathodes and is applicable to various next-generation batteries is needed.

### PRIOR ART

### Patent Documents

Patent Document 1: Korean Registered Patent No. 10-1741447 (Title: Insitu synthesis and deposition of battery active lithium materials by spraying, Date of Registration: May 24, 2017)
Patent Document 2: Korean Public Patent No. 10-2020-0133746 (Title: Method of applying printable lithium compositions for forming battery electrodes, Date of Publication: Nov. 30, 2020)

### DISCLOSURE

### Technical Problem

The present invention was invented to alleviate the above-mentioned problems, and one object of the present invention is to provide an ultra-thin lithium foil manufacturing apparatus using molten metal droplet spraying, capable of manufacturing thinner lithium films beyond the thickness limitations of existing manufacturing techniques while allowing precise thickness control.

Another object of the present invention is to provide an ultra-thin lithium foil manufacturing apparatus using molten metal droplet spraying, capable of implementing the manufacturing process as a continuous process and being applicable regardless of the surface type of a substrate.

The technical objects of the present invention are not limited to those mentioned above, and other technical challenges not mentioned herein will be clearly understood by those skilled in the art from the following description.

### Technical Solution

An ultra-thin lithium foil manufacturing apparatus using molten metal droplet spraying according to a preferred embodiment of the present invention devised to achieve the above-mentioned objects includes a crucible configured to apply heat to molten metal supplied from an external source to maintain a molten state of metal; a nozzle portion installed at one end of the crucible to eject the molten metal; a piezoelectric transducer installed at the other end of the crucible to transmit an excitation force to the molten metal in the crucible at a frequency set by a function generator; and a pressurizing pipe coupled to the crucible to transmit a pressurizing force to the molten metal, wherein the crucible and the nozzle portion move within a set range while the molten metal is ejected through the nozzle portion.

Furthermore, the crucible of an ultra-thin lithium foil manufacturing apparatus using molten metal droplet spraying according to a preferred embodiment of the present invention may include at least one or more heaters; a temperature sensor configured to measure a temperature of the molten metal or an outer surface of the crucible; and a vibrating shaft configured to vibrate due to the excitation force transmitted from the piezoelectric transducer.

Furthermore, the nozzle portion of the ultra-thin lithium foil manufacturing apparatus using molten metal droplet spraying according to a preferred embodiment of the present invention may include an adapter coupled to one end of the crucible; and a nozzle with a certain diameter coupled to the adapter to eject the molten metal inside the crucible to the outside.

### Advantageous Effects

According to one embodiment of the present invention, it is possible to provide an ultra-thin lithium foil manufacturing apparatus using molten metal droplet spraying, capable of manufacturing thinner lithium films beyond the thickness limitations of existing manufacturing techniques while allowing precise thickness control.

Furthermore, according to another embodiment of the present invention, it is possible to provide an ultra-thin lithium foil manufacturing apparatus using molten metal droplet spraying, capable of implementing the manufacturing process as a continuous process and being applicable regardless of the surface type of a substrate.

The effects of the present invention are not limited to those mentioned above, and other effects not mentioned herein will be clearly understood by those skilled in the art from the description of the claims.

### DESCRIPTION OF DRAWINGS

FIG. 1 is a photograph of an experimental apparatus configuration including a complete system for an ultra-thin lithium foil manufacturing apparatus using molten metal droplet spraying according to a preferred embodiment of the present invention.

FIGS. 2A and 2B are photographs of a portion of a crucible of an ultra-thin lithium foil manufacturing apparatus using molten metal droplet spraying according to a preferred embodiment of the present invention, a cross-sectional view to illustrate the internal structure of the crucible and a photograph of the nozzle shape.

FIGS. 3A and 3B are conceptual process diagrams for illustrating a metal droplet application process using an ultra-thin lithium foil manufacturing apparatus using molten metal droplet spraying according to a preferred embodiment of the present invention.

FIGS. 4A, 4B, 4C are conceptual diagrams for illustrating the calculation process of various numerical values related to an ultra-thin lithium foil manufacturing apparatus using molten metal droplet spraying and a metal droplet application process according to a preferred embodiment of the present invention.

FIG. 5 is a conceptual process diagram for illustrating each process of an ultra-thin lithium foil manufacturing apparatus using molten metal droplet spraying and a metal droplet application process according to a preferred embodiment of the present invention.

FIG. 6 is a shape change diagram for illustrating the change in shape of the ejection jet according to changes in pressurization force and excitation frequency during the droplet application process using an ultra-thin lithium foil manufacturing apparatus using molten metal droplet spraying according to a preferred embodiment of the present invention.

FIG. 7 is a photograph captured using an ultra-high-speed camera, of the ejection process of molten lithium droplets according to a preferred embodiment of the present invention.

### DETAILED DESCRIPTION

Hereinafter, a preferred embodiment of the present invention will be described in detail with reference to the accompanying drawings so that those skilled in the art to which the present invention belongs can easily practice the invention.

In describing the embodiments, technical details that are well known in the technical field to which the present invention belongs and that are not directly related to the present invention will be omitted. This is to convey the essence of the invention more clearly without obscuring it by omitting unnecessary explanations.

For the same reason, some components may be exaggerated, omitted, or schematically shown in the accompanying drawings. Also, the dimensions of each component do not necessarily reflect its actual size. In each drawing, identical or corresponding components are denoted by the same reference numerals.

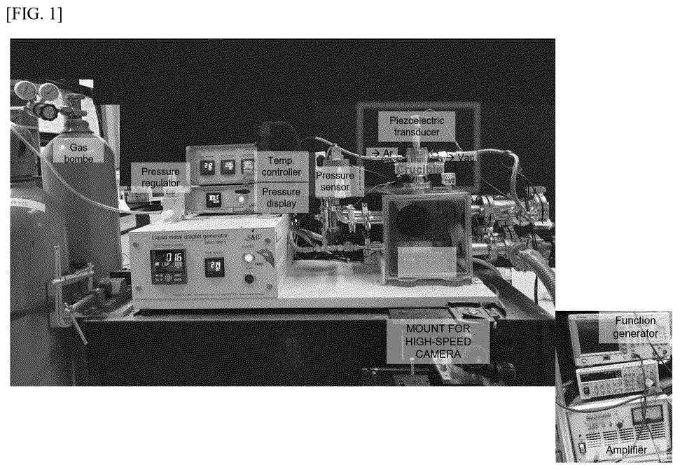

FIG. 1 is a photograph of an experimental apparatus configuration including a complete system for an ultra-thin lithium foil manufacturing apparatus using molten metal droplet spraying according to a preferred embodiment of the present invention.

Referring to FIG. 1, a complete system for an ultra-thin lithium foil manufacturing apparatus using molten metal droplet spraying according to a preferred embodiment of the present invention includes, from left to right in the direction of the drawing, a gas bombe, a pressure regulator, a temperature controller, a pressure display, a pressure sensor, a piezoelectric transducer, a crucible, a main chamber, a mount for a high-speed camera, a function generator, and an amplifier.

Here, it can be understood, on the right side of the drawing, the main parts are shown in red and blue dashed boxes, where the red dashed box includes the piezoelectric transducer and crucible, and the blue dashed box includes the main chamber.

The crucible applies heat to lithium to produce molten lithium, and the molten lithium is sprayed into the main chamber through a nozzle connected to the end of the crucible, and the crucible or nozzle portion is excited at a set frequency using the piezoelectric transducer.

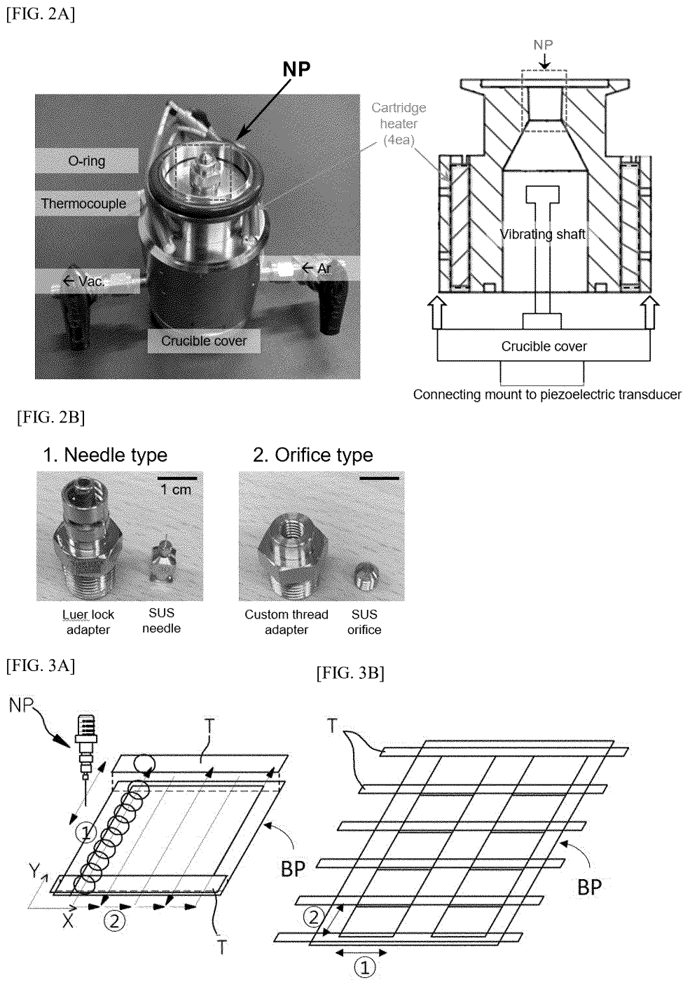

FIGS. 2A and 2B are photographs of a portion of a crucible of an ultra-thin lithium foil manufacturing apparatus using molten metal droplet spraying according to a preferred embodiment of the present invention, a cross-sectional view to illustrate the internal structure of the crucible and a photograph of the nozzle shape.

FIG. 2A shows a photograph and side cross-sectional view of a crucible included in an ultra-thin lithium foil manufacturing apparatus using molten metal droplet spraying according to a preferred embodiment of the present invention, and FIG. 2B shows a photograph of a nozzle portion NP and a nozzle included in the nozzle portion NP. It should be noted that in FIGS. 2A and 2B, the crucible and the nozzle portion NP are shown with their bottoms facing upward.

Referring to FIG. 2A, the crucible includes a nozzle portion NP coupled to a lower end thereof, an O-ring surrounding the outer surface of the lower end, a thermocouple (a temperature sensor using electromotive force) coupled to the outer circumferential surface, a cover covering an upper end thereof, a heater installed on the inner side of the outer circumferential surface, and a vibrating shaft extending inwardly from the cover.

Here, the vibrating shaft is connected to a piezoelectric transducer and has a function of exciting the molten metal in the crucible at a set frequency.

While the crucible of FIG. 2A is shown as having four heaters, the number of heaters is determined by considering various variables, such as the amount of heat required and the performance of the applied heaters, and can be freely determined as appropriate for each embodiment.

Referring to FIG. 2B, two examples of adapters and nozzles applicable to the nozzle portion NP are shown, including a needle type (1) and an orifice type (2).

The nozzle portion NP is replaceable and consists of an adapter and a nozzle, and only the nozzle can be replaced while the adapter is retained. However, in order to replace the nozzle with a different type of nozzle, the adapter must also be replaced.

The ultra-thin lithium foil manufacturing apparatus using molten metal droplet spraying of the present invention is aimed at spraying and ejecting lithium. However, since molten lithium has a problem of corroding most materials due to its high temperature (melting point 181° C.) and high reactivity of lithium, it is not possible to use needles and nozzles made of general materials and ceramic-based orifices, and only SUS materials have structural stability.

Furthermore, in order to prevent the nozzle from getting wet with lithium, it can be plated with copper or the like, which has a low affinity for lithium, and the ejection diameter of the nozzle can be adjusted to a small size by such plating.

An ultra-thin lithium foil manufacturing apparatus using molten metal droplet spraying according to a preferred embodiment of the present invention includes: a crucible configured to apply heat to molten metal supplied from an external source to maintain a molten state of metal; a nozzle portion installed at one end of the crucible to eject the molten metal; a piezoelectric transducer installed at the other end of the crucible to transmit an excitation force to the molten metal in the crucible at a frequency set by a function generator; and a pressurizing pipe coupled to the crucible to transmit a pressurizing force to the molten metal, wherein the crucible and the nozzle portion move within a set range while the molten metal is ejected through the nozzle portion.

Furthermore, the crucible of an ultra-thin lithium foil manufacturing apparatus using molten metal droplet spraying according to a preferred embodiment of the present invention includes at least one or more heaters; a temperature sensor configured to measure a temperature of the molten metal or an outer surface of the crucible; and a vibrating shaft configured to vibrate due to the excitation force transmitted from the piezoelectric transducer.

Here, the temperature sensor is typically a thermocouple.

Furthermore, the nozzle portion of the ultra-thin lithium foil manufacturing apparatus using molten metal droplet spraying according to a preferred embodiment of the present invention includes an adapter coupled to one end of the crucible; and a nozzle with a certain diameter coupled to the adapter to eject the molten metal inside the crucible to the outside.

Here, the material of the adapter and the nozzle is preferably SUS material as described above, and the inner surface of the nozzle can be plated with copper or the like to prevent the nozzle from getting wet with lithium, and the ejection diameter of the nozzle can be adjusted to a small size by plating.

FIGS. 3A and 3B are conceptual process diagrams for illustrating a metal droplet application process using an ultra-thin lithium foil manufacturing apparatus using molten metal droplet spraying according to a preferred embodiment of the present invention.

FIG. 3A is a diagram illustrating the application using a single nozzle, and FIG. 3B is a diagram illustrating the application using parallel nozzles.

Referring to FIG. 3A, 1 in a state in which the roll is aligned (stationary), the nozzle portion NP reciprocates in the Y-axis direction, and the applied droplets may partially overlap depending on the movement speed. Here, the circles shown along the Y-axis direction depict the assumed droplets applied.

\textcircled{2} After the end of the Y-axis movement, the roll is transferred (arrow in the X-axis direction) by the spread diameter of the droplet (black circle). However, some overlap with previous application rows may occur.

\textcircled{3} The trench Tis placed on the top of the roll to ensure that the application range is not exceeded.

Referring to FIG. 3B, \textcircled{1} the X-axis movement is the same as in the case of using a single nozzle, but a non-application area can be left at a certain distance according to the size of the electrode to be manufactured. Here, unlike the case of using a single nozzle in FIG. 3A, the areas separated by the boundary plate BP are in the center in addition to the left and right ends.

\textcircled{2} To prevent excessive overlap between nozzles, a number of trenches T are also arranged in parallel, and the spacing of the trenches T can be adjusted to match the spacing of the nozzles.

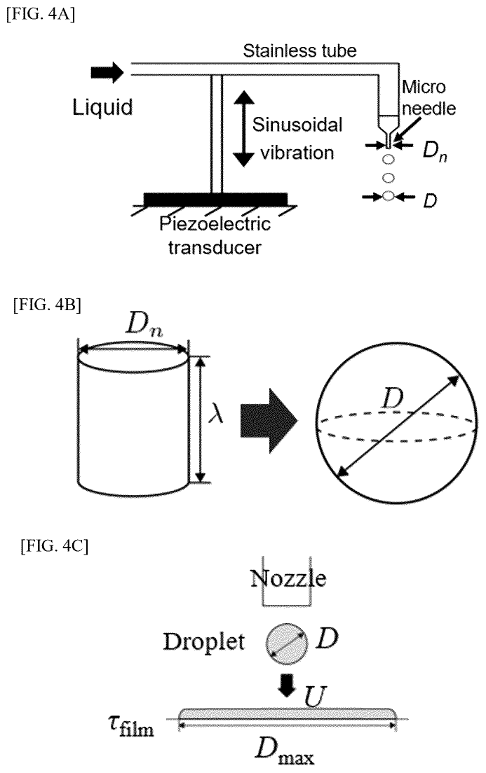

FIGS. 4A, 4B, 4c are conceptual diagrams for illustrating the calculation process of various numerical values related to an ultra-thin lithium foil manufacturing apparatus using molten metal droplet spraying and a metal droplet application process according to a preferred embodiment of the present invention.

Referring now to FIGS. 4A to 4C, the relationships of various variables related to an ultra-thin lithium foil manufacturing apparatus using molten metal droplet spraying and a metal droplet application process according to a preferred embodiment of the present invention will be described.

The diameter of the droplets is determined by the diameter of the nozzle, and there exists a range of suitable nozzle diameters Dn for producing droplets of a particular size (diameter D), wherein the suitable nozzle diameter Dn can be expressed as shown in Expression 1 below.

$$0. 46 D < {D}_{n} < 0.57 D \qquad ( Expression 1 )$$

Furthermore, when uₘᵢₙ is the ejection velocity at which a stable jet is produced through the nozzle, a relationship of Expression 2 is satisfied.

$${u}_{min} = \sqrt{\frac{8 γ}{ρ {D}_{n}}} \qquad ( Expression 2 )$$

In Expression 2, γ is the surface tension and p is the density.

Then, there exists a critical frequency to create enough instability in the jet sprayed from the nozzle to break up the jet at regular cycles, which can be calculated as shown in Expression 3, which also allows the wavelength distance between droplets to be calculated.

$${f}_{c} = \frac{{u}_{j}}{4.508 {d}_{j}} λ = \frac{{u}_{j}}{f} \qquad ( Expression 3 )$$

In Expression 3, dⱼ is the diameter of the jet, equal to Dn, uⱼ is the velocity of the jet, f_{c} is the critical frequency, and λ is the inter-droplet wavelength distance.
(Stricker, J., and D. Sofer. “Monosize droplet stream generator.” Review of scientific instruments 62.12 (1991): 3047-3050)

Now, using the values obtained from Expression 1 and Expression 3, the diameter of the droplet can be calculated as shown in Expression 4 below.

$$\frac{π}{6} {D}^{3} = \frac{π}{4} {D}_{n}^{2} λ D = {( \frac{3}{2} {D}_{n}^{2} λ )}^{1 / 3} \qquad ( Expression 4 )$$

Furthermore, the maximum spreading diameter can be obtained from the following experimental expression, Expression 5 (Yarin, Alexander L. “Drop impact dynamics: splashing, spreading, receding, bouncing.” Annual review of fluid mechanics 38.1 (2006): 159-192).

$$ξ = \frac{{D}_{max}}{D} = 0.61 {( \frac{{ρ}^{1.5} {D}^{1.5} {U}^{2}}{μ {γ}^{0.5}} )}^{0.166} \qquad ( Expression 5 )$$

In Expression 5, Dₘₐₓ is the maximum spreading diameter of the droplet, u is the kinematic viscosity, γ is the surface tension, and p is the density.

Furthermore, the thickness of the film (τ_{film}) can be estimated as shown in Expression 6 below.

$${τ}_{film} = \frac{2 {D}^{3}}{3 {D}_{max}^{2}} \qquad ( Expression 6 )$$

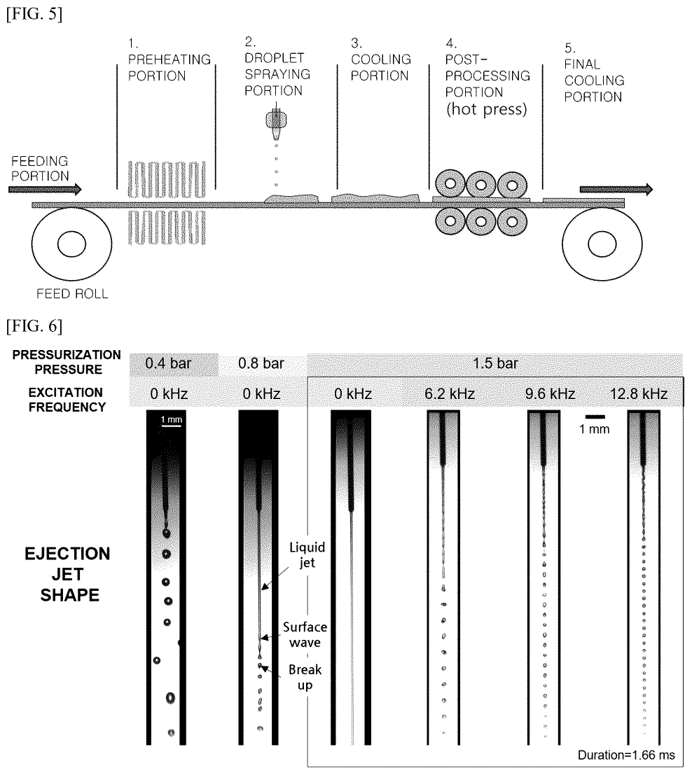

FIG. 5 is a conceptual process diagram for illustrating each process of an ultra-thin lithium foil manufacturing apparatus using molten metal droplet spraying and a metal droplet application process according to a preferred embodiment of the present invention.

Referring to FIG. 5, a film that is a substrate is fed through a feeding portion and a feed roll on the left side, passes through a preheating portion to raise the surface temperature to an appropriate level, and passes through a droplet spraying portion, and metal droplets are ejected to a desired area of the surface of the substrate or film.

The metal droplets are then hardened in the cooling portion, the surface of the hardened metal droplets is refined by hot pressing or other processes in a post-processing portion, and the process is completed in a final cooling portion.

Additional processes may be performed at a later stage depending on the needs of the battery manufacturing process.

FIG. 6 is a shape change diagram for illustrating the change in shape of the ejection jet according to changes in pressurization force and excitation frequency during the droplet application process using an ultra-thin lithium foil manufacturing apparatus using molten metal droplet spraying according to a preferred embodiment of the present invention.

In the test to confirm the change in shape of the droplet according to changes in the pressurization force and excitation frequency as shown in FIG. 6, water was used as the liquid.

Referring to FIG. 6, in a case where droplets are applied through a 0.3 mm-diameter nozzle, when the pressure applied to the molten metal in the crucible to spray water from the nozzle tip is 0.4 bar, the droplets are ejected evenly from the nozzle tip and then break up into uneven droplets. When the pressure is increased to 0.8 bar beyond the critical pressure required for continuous jet formation, a liquid jet of a certain length is formed from the nozzle tip, but any disturbance causes instability at the interface of the jet, and the surface wave is amplified as it travels downstream, causing the jet to break up into droplets.

In order to form a more stable jet, when the pressure is then increased to 1.5 bar to form a stable continuous jet and excited at a constant frequency, the jet can be broken up into uniform droplets through uniform surface waves. It was found that as the excitation frequency increased from 0 kHz to 6.2 kHz, 9.6 kHz, and 12.8 kHz, the droplets became smaller and the inter-droplet distance became smaller, with the smallest droplet size and distance at the excitation frequency of 12.8 kHz.

Thus, it was found that the liquid sprayed through the nozzle was broken up into droplets at regular intervals before forming droplets, which formed regular intervals after descending a certain distance after being sprayed from the nozzle.

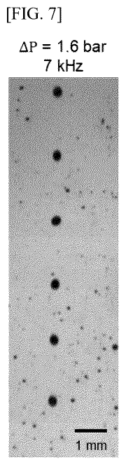

FIG. 7 is a photograph captured using an ultra-high-speed camera, of the ejection process of molten lithium droplets according to a preferred embodiment of the present invention.

This photograph shows the results when the inside of the crucible was pressurized to 1.6 bar and the frequency was set to 7 kHz to spray the molten metal from the nozzle.

Lithium, which has very different properties from water, requires different conditions to form consistent droplets than water. In other words, capturing the right droplet generation conditions in the target liquid is essential for the present invention.

Referring to FIGS. 1 to 7 above, an ultra-thin lithium foil manufacturing apparatus using molten metal droplet spraying according to a preferred embodiment of the present invention has been described.

Meanwhile, although the present specification and the drawings disclose preferable embodiments of the present disclosure, and use certain terms, this is to help understand the present disclosure more easily, and not to limit the scope of the present disclosure. It will be apparent to those skilled in the art that other modified examples that are based on the technical concept of the present disclosure can be implemented as well besides those disclosed herein.

### REFERENCE SIGNS LIST

BP Border plate
NP Nozzle portion
T Trench

1. An ultra-thin lithium foil manufacturing apparatus using molten metal droplet spraying, comprising:
a crucible configured to apply heat to molten metal supplied from an external source to maintain a molten state of metal;
a nozzle portion installed at one end of the crucible to eject the molten metal;
a piezoelectric transducer installed at the other end of the crucible to transmit an excitation force to the molten metal in the crucible at a frequency set by a function generator; and
a pressurizing pipe coupled to the crucible to transmit a pressurizing force to the molten metal, wherein
the crucible and the nozzle portion move within a set range while the molten metal is ejected through the nozzle portion.

2. The ultra-thin lithium foil manufacturing apparatus using molten metal droplet spraying according to claim 1, wherein
the crucible comprises:
at least one or more heaters;
a temperature sensor configured to measure a temperature of the molten metal or an outer surface of the crucible; and
a vibrating shaft configured to vibrate due to the excitation force transmitted from the piezoelectric transducer.

3. The ultra-thin lithium foil manufacturing apparatus using molten metal droplet spraying according to claim 1, wherein
the nozzle portion comprises:
an adapter coupled to one end of the crucible; and
a nozzle with a certain diameter coupled to the adapter to eject the molten metal inside the crucible to the outside.
